(19) United States
(12) Patent Application Publication
(10) Pub. No.: US 2008/0228688 A1
(43) Pub. Date: Sep. 18, 2008

(54) PRODUCTION RULE SYSTEM AND METHOD

(76) Inventor: Tao Liu, Kitchener (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/687,283

(22) Filed: Mar. 16, 2007

(51) Int. Cl. G06N 5/02

(52) U.S. Cl. 706/48

(57) ABSTRACT

A production rule system includes a condition part array including an arrangement of condition part elements. Each of the condition part elements includes a condition value corresponding to an evaluation of one of a plurality of condition parts. A production part array includes an arrangement of production part elements, each of the production part elements comprising one of a plurality of production parts corresponding to an executable action. A data structure selectively associates at least one of the condition part elements with each of the production part elements to define a plurality of rules. The production part associated with a given rule of the plurality of rules can be executed depending on the condition value for the at least one of the condition part elements in the given rule. A self-adaptive mechanism can be employed in the system to improve system performance and computational efficiency.

### TECHNICAL FIELD

The present invention relates generally to systems and methods that can be operate as a production rule system, such as a rules engine.

### BACKGROUND

A variety of different production rule systems, also referred to as rules engines, have been developed. A rules engine generally includes a one or more conditions that, if satisfied, result in a predefined production being performed. There are two general types of rules engines. A first type of rules engine is reactionary in that production may be performed in response to a user input of parameters or questions. A second type of rules engine detects and reacts automatically when a certain condition or set of conditions is achieved.

As one example, a rules engine can be programmed to perform the Rete algorithm. The Rete algorithm is a pattern-matching algorithm designed to evaluate a large number of complex, inter-related rules. The Rete algorithm can provides a basis for an efficient implementation of a rules engine, such as may employ artificial intelligence or an expert system. The Rete algorithm uses a tree as its core data structure. For example, a Rete-based expert system typically builds a network of nodes, where each nod (except the root node) corresponds to a pattern occuring in the left-hand of a rule. The pate from the root node to a leaf node defines a complete left-hand-side of the rule. The network of nodes, as the core data structure in the rules engine, can require incriesed memory consumption and decrease performance in certain applications.

### SUMMARY

The invention relates to a production rule system and to an associates method.

One aspect of the invention provides a production rule system that includes an arrangement of condition part elemetents. Each of the condition part elements includes a condition value corresponding to an evaluation of one of a plurality of condition parts. The system includes an arrangement of production part elements, each of the production part elements comprising one of a plurality of production parts corresponding to an executable action. A data structure selectively associates at least one of the condition part elements with each of the production part elements to define a plurality of rules. The production part associated with a given rule of the plurality of rules can be executed depending on the condition value for the at least one of the condition part elements in the given rule.

Another aspect of the invention relates to a production rule system that includes means for storing a plurality of condition part elements, each of the plurality of condition part elements representing an elvaluation of a respective one of a plurality of condition parts. The system also includes means for storing production part elements, each of the production part elements comprising one of plurality of production parts corresponding to an executable action. The system also includes means for associating at least one of the condition part elements with each of the production part elements for providing each of a plurality of rules. The system also includes means for executing the production part associated with a given rule of the plurality of rules depending on a value of the at least on of the condition part elements in the given rule.

Still another aspect of the invention relates to an embedded system comprising a processor and memory. Usually an embedded system does not have powerful processor and a large amount of memory avaliable. The embedded system contains executable instructions in the memory for performing a method that includes evaluating expressions for each of a plurality of condition parts and populating condition part elements with values based on the evaluation of expressions. At least one of the condition part elements is associated with each production part element corresponding to a respective one of a plurality of production parts. Each of the plurality of production parts for a given rule of the plurality of rules can be executed depending on the value of the at least one condition part element that is associated with the respective production part element.

### BRIEF DESCRIPTION OF THE DRAWINGS

FIG. 1 depicts an example block diagram of a rules engine that can be implemented according to an aspect of the invention.

FIG. 2 depicts another example of a rules engine that can be implemented according to an aspect of the invention.

FIG. 3 depicts an example of a rule data structure that can be implemented as part of a rules engine according to an aspect of the invention.

FIG. 4 depicts an example of a system for adapting a rules engine that can be implemented according to an aspect of the invention.

FIG. 5 depicts a functional block diagram of an example of part of a rules engine that includes a sef-adapting mechanism according to an aspect of the invention.

FIG. 6 depicts an example of an embedded system that can be implemented according to an aspect of the invention.

FIG. 7 is a flow diagram depicting a method for implementing a rules engine according to an aspect of the invention.

FIG. 8 is a flow diagram depiction a method that can be utilized for implementing a self-adaptive feature in a rules engine according to an aspect of the invention.

### DETAILED DESCRIPTION

The present invention relates generally to a production rule system (also referred to herin as a rules engine) and method. The production rule system and methods described herein can be implemented in an embedded system.

As will be appreciated by those skilled in the art, portions of invention may be embodied ans a method, data processing system, or computer program product. Accordingly, these portions of the present invention may take the form of an entirely hardware embodiment, an entirely software embodiment, or an ebodiment combining software and hardware. Furthermore, portions of the invention may be computer program product on a computer-usable storage medium having computer readable program code on the medium. Any suitable computer-readable medium may be utilized including, but not limited to, static and dynamic storage devices, hard disks, optical storage devices, and magenetic storge devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that eh intructions, which execute via the processor, a production rule system and method may be implemented in an embedded system, such as by a processor performing executable instructions stored in memory of the embedded system.

These computer-executable instructions may also be stored in computer-readable memory that can direct a computer or other programmable data processing apparatus to function in a particular manner, such that the instructions stored in the computer-readable memory result in an article of manufacture including instructions which implement the fucntion specified in the flowchart block or blocks. The computer program instructions may also be loaded onto a computer or other programmable data processing apparatus (e.g., in an embedded system) to cause a series of operational steps to be performed on the computer or other programmable apparaus to produce a computer or other programmable apparatus provide steps for implementing the functions specified in the flowchart block or blocks.

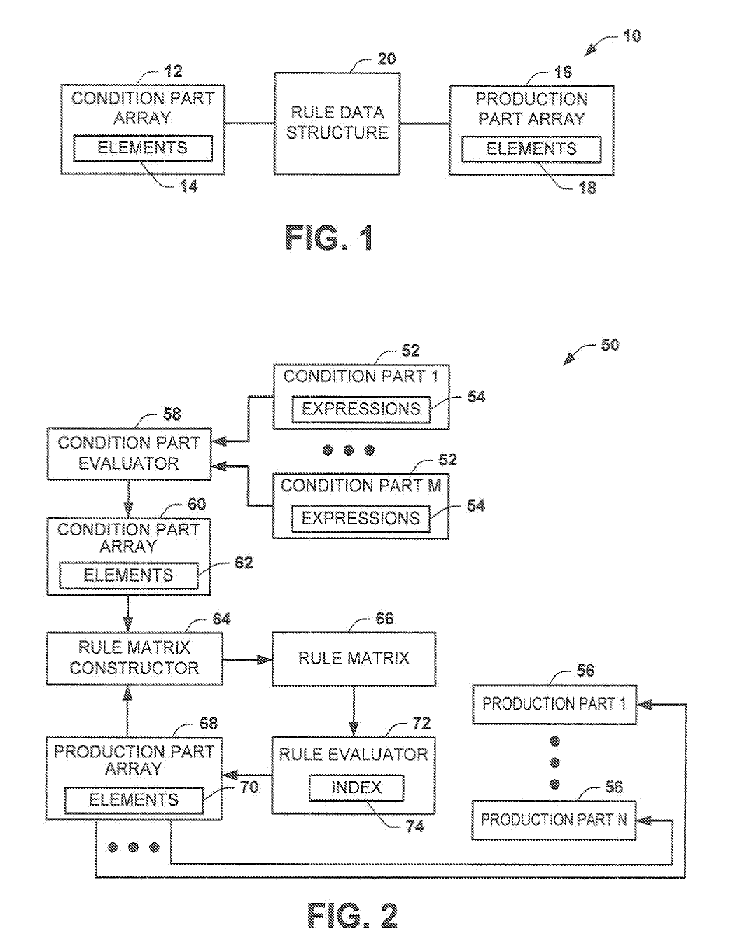

Turning to FIG. 1, an example production rule system 10 is depicted. The prodution rule system 10 includes an arrangement of condition part elements 14. The arrangement of condition part elements 14, for example, can be implemented in the form of an array or other type of data structure (e.g., linked list, queue, stack and the like). For purposes of consistency and simplicity of explanation, the arrangement of condition part elements 14 is described herein as being an array 12 of the condition part elements. The condition part elements 14 each has a value corresponding to an evaluation of one or more condition parts. Each condition part can correspond to a particular expression, such as a Boolean expression or other conditional expression that can represented a relationship between parameters. The parameters can correspond to a set of operating parameters, input values for parameters, outputs from one or more other processes, which may vary according to the application for the rule system 10.

The production rule system 10 also includes an arrangement of production part elements 18. The arrangement of production part elements 18, for example, can be implemented in the form of an array or other type of data structure (e.g., linked list, queue, stack and the like). For purposes of consistency and simplicity of explanation, the arrangement of production part elements 18 is described herein as being an array 16 of the production part elements 18. Each of the production part elements 18 is associated with one of a plurality of production parts. Each production part corresponds to an executable action that can be executed according to a value determined for a respective production part element 18. For instance, the execution of a given production part may depend on one or more associated condition parts of a given rule being met or satisfied.

The system 10 also includes a rule data structure 20. The rule data structure 20 associates one or more of the condition part elements 14 with each of the respective part elements 18 to define each of the rules in the system 10. Thus, there typically will be a one-to-one correspondence between the number of rules and the number of production parts in the system 10. As a result, the production part associated with a given rule is executed depending upon the value or values of the condition part elements 14 that, in aggregate, form part of the rule associated with such production part.

An evaluator (not shown) can evaluate each of the condition parts in the conditions part array 12 and provide a condition part value based on the evaluation. The condition value can be stored in the condition part elements 14 of the array 12. For example, each of the condition part elements 14 can be represented by a Boolean expression that is evaluated to provide a condition value that is stored in the condition part array 12.

As an example, the rule data structure 20 can be implemented as a matrix (e.g., a two dimensional matrix) in which the values in the matrix selectively associate one or more of the condition part elements with each of the production part elements. This association thus defines the rules for the system by establishing (according to the matrix elements in the rule matrix) on which condition part or set of condition parts the execution of each production part depends. For example, each of the matrix elements of the rule matrix can include a binary value in which one value indicates that the production part depends on an associated condition part and another value indicates that the production part is independent of the associated condition part. As used herein the term “binary” and variation thereof is intended to encompass any way of representing a parameter having two possible states or values. Examples of binary value representations include true or false, 0 or 1, high or low, to name of few. Additional functionality may be implemented in the system 10 to sort or reorder the elements 14 of the condition part array to improve performance and evaluation of each of the rules.

As a further example, the production rule system 10 can be implemented as an embedded system, such as executable instructions that may be implemented by a processor having memory in which the rules engine system 10 can be implemented. It would be further understood and implemented that a set of rules may be implemented as a plurality of rule systems 10, in which each rule system includes a set of related condition parts and production parts associated with each other via a respective rule data structure, such as described herein. Since the condition parts array can be reduced for a set of related production parts, the aggregate size of the rule data structures (e.g., rule matrices) can be reduced relative to implementing a single rule data structure that interrelates all condition parts with all production parts. Consequently, efficiencies can be achieved for implementing a production rule system according to an aspect of the invention.

FIG. 2 depicts an example of another production rule system 50 that can be implemented according to an aspect of the invention. The rule system 50 can be employed as a rules engine in the variety of contexts. For instance, the rule system 50 can be generically applied to implement business rules, such as for controlling other processes or for a performing decision making. Alternatively or additionally, the rule system 50 can be utilized as part of an embedded system (e.g., including a processor and appropriate memory storage) programmed for implementing defined action under a variety of user-defined circumstances.

In the example of FIG. 2, the system 50 includes a plurality of condition parts 52, indicated at Condition Part 1 through Condition Part M, where M is a positive integer denoting the number of condition parts in the system 50. The number M may be fixed or it may vary during system operation. Each of the condition parts 52 includes one or more conditional expressions 54, such as may vary as a function of one or more parameters. For example, each of the expressions 54 can be implemented as one or more Boolean expressions. When a condition part includes multiple Boolean expressions, such expressions can be connected by appropriate Boolean operators (e.g., OR, AND, Exclusive-OR, etc.). Some condition parts may contain one or more of the same expressions 54 or the expressions for each condition part can be different. By way of example, a condition part (CP) can be represented as follows:

CP=C₁ [symbol] C₂ [symbol] . . . [symbol] Cₖ,

where each C₁ is a Boolean expression, and
k is a positive integer (k≧1) denoting the number of expressions.
   The condition part in a given rule Ruleⱼ thus can be denoted as CPⱼ.

Each of the rules in the system 50 can be represented as including a condition part 52 and one or more production parts 56. In the example of FIG. 2, the production parts 56 are schematically indicated at production part 1 through production part N, where N is a positive integer denoting the number of production parts in the system 50. As one example, each rule may be considered an IF-THEN statement that contains a set of one or more condition part and a respective production part (PP), such as follows:

Ruleᵢ [symbol] =IF CPᵢ THEN PPᵢ

Each production part 56 corresponds to an executable instruction (or code segment) that can be invoked or executed in response to each of the condition parts of a given rule being satisfied.

The rule system 50 includes a condition part evaluator 58 that evaluates each of the condition parts 52. For example, the condition part evaluator 58 applies a set of input data and/or other information to the expressions 54 to determine values for the condition parts. The condition part evaluator 58 can in turn populate a condition part array 60 based upon the evaluation of each of the respective condition parts 52. The results of the evaluation can be populated as condition values into condition part elements 62 of the condition part array 60. For example, each condition part element 62 can include a binary value (e.g., 0 or 1; true or false) that indicates whether each given condition part 52 has been satisfied. Consequently, in a situation when each the expressions 54 of a condition part 52 are ANDed together to define the condition part, if the expressions 54 that forms a respective condition part are true, the resulting condition part is also true. In contrast, if any of the expressions is false, the condition part is also false.

The rule system 50 also includes a rule matrix constructor 64 that is programmed to construct a corresponding rule matrix 66. The rule matrix 66 is constructed to selectively associate one or more of the condition parts 52 with each of the production parts 56. The rule matrix 66 can be implemented as a two-dimensional matrix containing a plurality of matrix elements. Each of the matrix elements has a value that selectively associates (or disassociates) a subset of the condition part elements 62 with a respective one of the production parts 56. The association (provided by the rule matrix 66) between the condition part elements 62 and the production part elements 70 thus is utilized to define each rule implemented in the rule system 50.

The system 50 also includes a production part array 68 that includes production part elements 70 associated with each of the production parts 56. Each of the production part elements 70 has a value that can be set to enable or disable execution of the associated production part. For example, the each of the production part elements 70 can store the aggregate results of the evaluation of the condition parts in each of the rules in the rule matrix 66.

As described herein, each of the rules contains one or more condition parts that, if satisfied, enables the execution of a related one of the production parts 56. A rule evaluator 72 is operative to evaluate each of the condition parts in a given rule according to a rule index 74. The index 74, for example, provides a mechanism to traverse the condition part array 60 for one or more of the rules so that the rule evaluator 72 can determine whether the condition parts associated with each given production part are true. The results of the rule evaluation can be stored as the production part elements 70 in the production part array 68. For instance, the condition parts for each respective rule, as defined by the rule matrix66, can be evaluated individually such that a corresponding value (e.g., a binary value) can be stored into the production part array 68 for indicating whether execution of the associated production part is enabled.

As one example, for a given rule, the condition part elements 62 for each selected matrix element in the rule matrix 66 can be logically ANDed together to ascertain whether the production for the respective rule is enabled. For instance, if the rule evaluator 72 determines that each of the associated condition part elements 62 for the given rule is true (or a logic 1), a corresponding binary value (e.g., true or logic 1) can be stored in the production part element 70 associated with such rule. This enables execution of the production part 56 corresponding to the production part element 70. In contrast, if any one or more of the condition part elements 62 in a given rule is false, the rule evaluator 72 populates the associated the production part element 70 with a corresponding binary value (e.g. false or logic 0), indicating that the production part for that rule is not enabled. The index 74 thus can index through the set of rules such that resulting production values are populated in the production array for each iteration thereof.

As another example the elements 62 of the condition part array 60 may be dynamically arranged in an order according to the frequency of which each condition part has a predetermined value. The predetermined value correspond a binary value, such as true or false. Alternatively, the predetermined value can be another value or range of values determined to indicate a ranking among condition parts 52 that can afford computational efficiency in evaluating the condition parts. The sorting of the condition part elements 62 in the array 60 may be performed with each iteration of the rule system. Alternatively, the sorting can be performed periodically, such as based on a defined number of iterations or periodically as a function of time. Yet another alternative would be to perform the sorting in response to a predefined trigger, such as may be provided by another process (not shown).

According to one example, the frequency at which a given condition part is false can be employed as the predetermined value to reorganize the elements 62 of the condition part array. For instance, condition part elements 62 determined to have an increased likelihood of being false can be moved to the beginning of the condition part array 60. The rule evaluator 72 can be further programmed to terminate evaluation of condition parts for a given rule in response to detecting a single condition part of the given rule is false. As a result, since condition part elements having an increased likelihood of being false reside near the beginning of the array 60, the value of each production part being false can be determined with increased efficiency.

Since a single set of condition parts are associated with a corresponding set of production parts, it will be appreciated that one or more unique expression sets can be constructed from the condition parts that are used in the system 10. For example, the set of expressions can be referred to as a unique expression set (UES) that can be represented as follows:

$$UES = {{⋃}_{j = 1}}^{M} {CP}_{j}$$

where CPⱼ represents each of a plurality of M condition parts in the UES.
   Similarly, all the productions parts 56 can be considered a set of productions, e.g., a production set (PS), in which

PS={PP₁, PP₂, . . . PP_{N}}
where N denotes the number of production parts 56.
   Thus given a set of rules, a unique expression set and a production set can be determined that can be further associated between the condition part array 12 and the condition part array 16 via the rule data structure 20.

By way of further example, if each production part 56 depends on only a few condition parts 52, the rule matrix 66 tends to become a sparse matrix, which can result in memory being wasted. For example, if a given production part (PP1) depends only on two condition parts (CP1 and CP2), the memory for CP3 to CPN can be considered wasted since CP3 or CPN are not related to PP1. If some condition parts are not related to a given PP, it does not make sense to put them together. Therefore, a potentially large matrix can be divided into a plurality of smaller matrices, in which only related condition parts and production parts are associated by a given one of the smaller rule matrices. By dividing a large sparse matrix into multiple cases, memory can be saved. Additionally, such use of the plural smaller matrices can also improve execution of the code program as well as simplify maintenance of the code program.

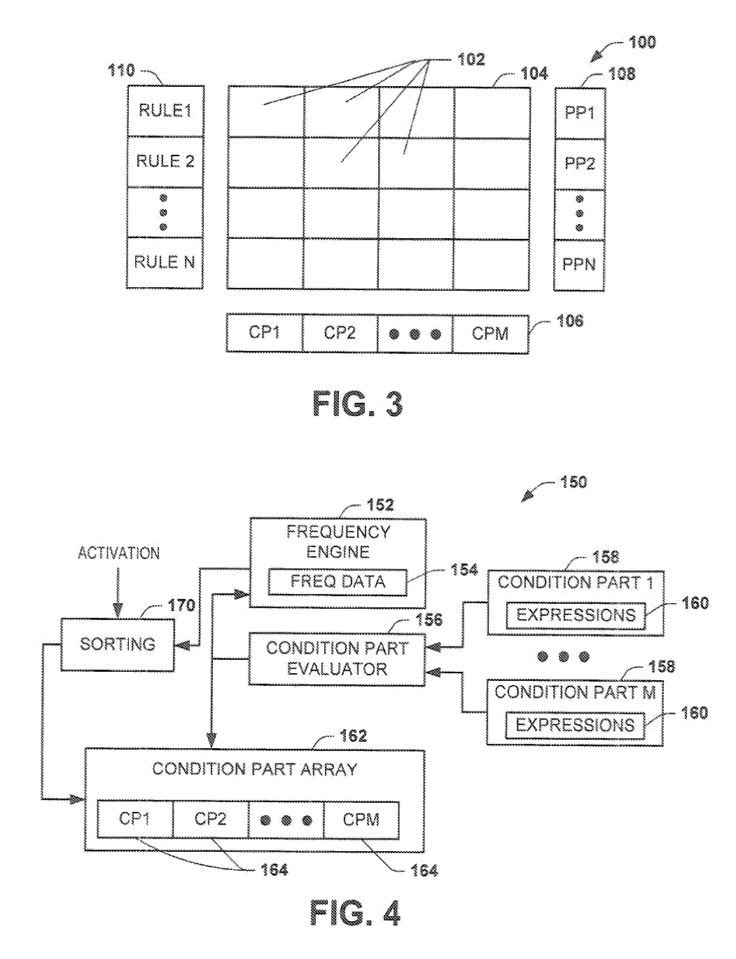

FIG. 3 depicts an example of a rule data structure 100 that can be implemented according to an aspect of the invention. A rules engine can implement any number of such rule data structures 100, each corresponding to a case that includes a UES and related production set. The rule data structure 100 includes a plurality of matrix elements 102 arranged in a two-dimensional matrix 104, such as may operate as the core of a production rule system (or rules engine). A first dimension of the matrix 104 corresponds to a condition part array 106 and another dimension of the matrix corresponds to production part array 108. The condition part array 106 includes a UES of condition parts that are represented as condition part elements, indicated at CP₁ through CP_{M}, where M is a positive integer denoting the number of condition parts in the UES. The production part array 108 contains the production part elements, indicated at PP₁ through PP_{N}, where N is an integer denoting the number of production parts associated with the rule data structure 100.

In the example of FIG. 3, each column of the matrix 104 corresponds to a respective one of the condition part elements of the condition part array 106. Similarly, each row of the matrix corresponds to one of the respective production part elements of the production part array 108. Accordingly, by setting the values of each of the matrix elements 104, a subset of one or more of the condition part elements are selectively associated with a given one of the production part elements which operate to define each of a plurality of rules 110, indicated at Rule 1 through Rule N.

By way of further example, each element of the matrix 102 can be represented as a binary value such that a single bit is sufficient to hold the status of the respective element 104, indicating whether a given condition part forms part of each associated rule. Binary values can also be utilized with respect to the condition part elements of the condition part array 106 and the values of the production part array elements 108. For instance, the value for each condition part element in the array 106 indicates whether the expression or expressions associated with the respective condition part has been met. In response to evaluating the selected condition part(s) for a given rule (e.g., by employing a Boolean AND operator to the condition part elements), a resulting value can be populated to the respective production for such rule. By storing binary values for each of the matrix elements 102, the condition part elements and for the production part elements, the amount of memory required to implement the rule data structure 100 depends on the number of production parts times the number of condition parts. For example, assuming 512 production parts and 32 condition parts, the rule data structure utilizes about 2052 bytes of memory.

FIG. 4 depicts an example of part of a rules engine 150 employing a self-adaptive mechanism that can improve system performance and computational efficiency. The system 150 includes a frequency engine 152 that is programmed to ascertain a frequency at which a given condition part will have a predetermined value, which value may be programmable and further may represent a unique value or a range of values. The frequency can correspond to a likelihood or probability that the condition part will have the predetermined value. Additionally, the frequency can be represented as an absolute frequency as a function of time (e.g., how many times the condition part has the predetermined value in a known time period or over a known number of iterations). Alternatively, the frequency may represent a relative frequency among the respective condition parts.

The frequency engine 152 thus can maintain a set of frequency data 154 that identifies the frequency associated with each of the condition parts. For example, the frequency data 154 can be implemented as an array having the same size as the condition part array to which it is applied. That is, the frequency data 154 may be implemented as a frequency array of a size commensurate with number of condition parts employed in the corresponding production rule system.

The system 150 includes a condition part evaluator 156 that is configured to ascertain the value of each of the respective condition parts 158. As described herein, each of the respective condition parts can be implemented as one or more expressions 160. Those skilled in the art will understand and appreciate various types of logical and mathematical expressions that can be implemented as the expressions 160 for each of the respective condition parts 158. For each iteration of the rules engine, the condition part evaluator 156 determines a value for each of the expressions 160 of the respective condition parts 158. As an example, the condition part evaluator 156 can evaluate each condition part 158 to determine a binary value (e.g., true or false) indicating results of the expressions for each respective condition part. In such example, the frequency engine 152 can be programmed to ascertain an indication of the frequency at which each of the respective condition parts 158 is false. Alternatively, the frequency engine 152 can ascertain the frequency at which each of the respective condition parts 158 is true.

The condition part evaluator 156 populates elements (CP1, CP2, . . . CPM) 164 of a condition part array 162 with the value determined for each of the condition parts 158. The condition part evaluator 156 can also provide the determined value of the respective condition parts 158 to the frequency engine 152. The frequency engine 152 thus can update the frequency data 154 based on the values determined by the condition part evaluator. As one example, the frequency data 154 may include a count value indicating the number of false values for each of the respective condition parts 158, such as over a known time period or number of iterations.

the self-adapting mechanism 150 further includes a sorting function 170 that is programmed to sort the elements 164 of the condition part array 162 based on the frequency data 154. The sorting function 170 can be implemented in response to an activation signal to dynamically arrange the condition part elements 164. The activation signal can be provided to invoke the sorting of the condition part array 162, such as may occur each iteration, periodically or as otherwise determined, for adjusting the order of the condition part array.

As one example, the sorting function 170 can move condition part elements having a greater likelihood of being false toward one end of the array, such as to the beginning of the array that is first evaluated during the evaluation of the respective rules. For instance, it may be assumed that a lower index value in the condition part array 162 corresponds to the beginning of the array, such that CP1 in the condition part array 164 corresponds to the condition part element having the highest likelihood of being false, CP2 has the next highest likelihood or equal to CP1 and so forth, and CPM having the lowest likelihood of being false. Over a plurality of iterations, the condition parts elements having a higher likelihood of being false will be moved to the beginning of the array such that search time for implementing the rules engine can be decreased accordingly.

In an example where the selected condition parts for a given rule are ANDed together to determine whether to enable a respective production part, if any condition part associated with the respective production part is determined to be false, that production part can be disabled. Therefore, in response to detecting any condition part as being false, the production part for each rule that contains such false condition part can be disabled. When the search of condition parts for each given rule begins at the lower index condition part element (arranged to have a greater likelihood of being false), there is an increased likelihood a false condition part element will be encountered early in the search process. Such a self-adaptive technique thus can reduce computations associated with evaluation of given set of rules and thereby improve system performance.

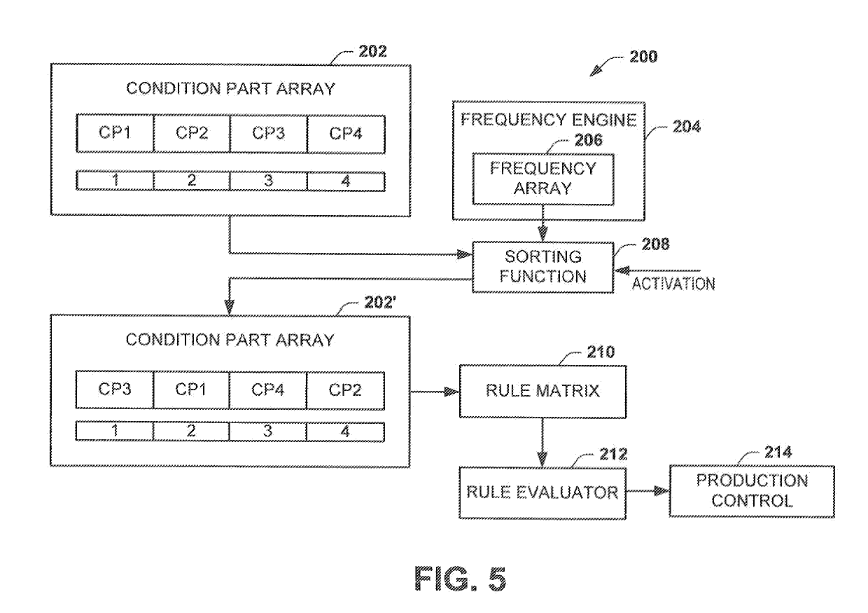

The self-adaptive function of the rule system will be better appreciated with reference to FIG. 5, illustrating a self-adaptive approach that can be employed in a rule system. In the example of FIG. 5, a condition part array 202 includes four condition parts, indicated at CP1, CP2, CP3 and CP4. The values of the condition part elements CP1 through CP4 can be provided to a frequency engine 204 that is programmed to determine the frequency at which a given condition part is false. As described herein, the frequency for each condition part can be stored in a frequency array 206. The elements of the frequency array 206 can be matched with or otherwise associated with corresponding condition part elements of the condition part array 202. The frequency array 206 thus stores a value associated with each of the condition parts for indicating the frequency at which a respective condition part is false. The value can be a count (e.g., a over a predefined time interval or number of iterations) or the value can be a likelihood determined based on the evaluation of condition part elements over a period of time.

A sorting function 208 is programmed to re-order the condition part elements CP1 through CP4 into an order that varies as a function of the frequency data in the frequency array 206. The sorting function 208 can be activated to perform such sorting in response to an activation signal. When the activation signal invokes the sorting function 208, the sorting function orders of the condition part elements in the condition part array 202 to provide a new order of the elements in the condition part array, indicated at 202′. In the example of FIG. 5, the condition part elements have been reordered such that CP3 is the first element CP1 is second element, CP4 is the third element and CP2 is the fourth element. Assuming that the beginning of the array is with element 1, the new order generally indicates that CP3 is more likely to be false and CP1, and CP1 is more likely to be false than CP4, and CP4 is more likely to be false than CP2.

By rearranging the condition part array, the order of condition parts associated with the corresponding rule matrix 210 is also rearranged. Consequently, as the rule evaluator 212 searches through the rule matrix 210 and the associated condition part elements in the rearranged condition part array 202′, the rule evaluator will evaluate condition part elements having a greater frequency of being false before evaluating condition part element more likely to be true. The rule evaluator 212 further can be programmed to terminate its search of condition part elements for a given rule in response to detecting a condition part element for a given rule having a false value. If the condition parts for the given rule is true, the rule evaluator can populate the production part element for such rule to enable production. After the production part elements have been populated by the rule evaluator, a production control block 214 can execute production parts that have been enabled. The self-adaptive mechanism enables increased computational efficiency relative to many existing rule engines. As a result, a production rule system employing the self-adaptive functionality affords desirable performance for use in a variety of applications.

Those skilled in the art will understand and appreciate that the examples of production rule systems shown and described herein are well adapted for use in embedded systems. Many embedded system may have requirements of increased computational efficiency and reduced memory requirements.

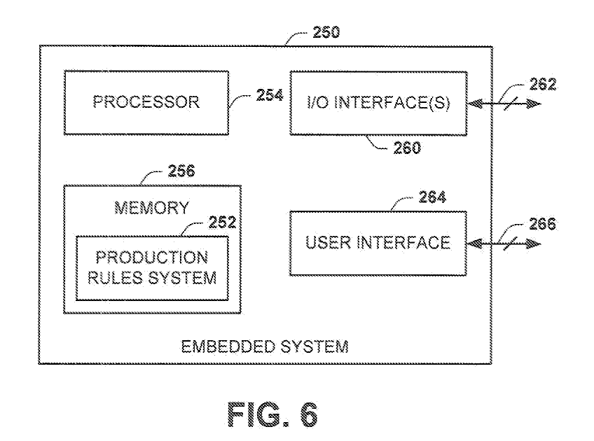

FIG. 6 depicts an example of a schematic block diagram of an embedded system 250 that can be programmed to employ a production rule system 252 according to an aspect of the invention. The embedded system 250 includes a processor 254, such as a microprocessor, a graphics processor, arithmetic logic unit or the like. The embedded system also includes memory 256. The memory can include one or more memory storage devices, such as including non-volatile memory (e.g., read only memory (ROM), programmable memory, such as flash memory) and volatile memory (e.g., random access memory (RAM), such as static RAM or dynamic RAM). The memory includes contains computer-executable instructions for performing predetermined functionality, including the production rule system 252. Those skilled in the art will understand and appreciate various ways to program the memory to operate and implement a production rule system based on the teachings contained herein (see, e.g., FIGS. 1-5 and 7 and 8).

The embedded system 250 can interact (e.g., provide information or instructions) with external devices via one or more input/output interface 260. The I/O interface 260 can provide and/or receive information and instructions via one or more connections 262, such as may define data bus or plurality of electrical, optical or wireless communication links. The embedded system may also include a user interface 264 through which is a user may enter commands and information into the embedded system 250, such as through another device (e.g., a keyboard, and a pointing device or mouse or other control panel), such as may correspond to graphical user interface and/or to one or more input terminal. These and other input devices are often connected to the embedded system 250 through a corresponding port interface or connections indicated at 266.

Those skilled in the art will understand and appreciate various types and configurations of embedded systems that can be programmed and/or configured to employ the production rule system 252. As one example, the embedded system 250 can employ the production rule system 252 in connection with rendering video signals, computer signals or a combination of video and computer signals (e.g., provided via the connections 262) to one or more displays or monitors (not shown). Those skilled in the art will understand and appreciate various other applications and uses for the embedded system 250, such as including commercial and military applications.

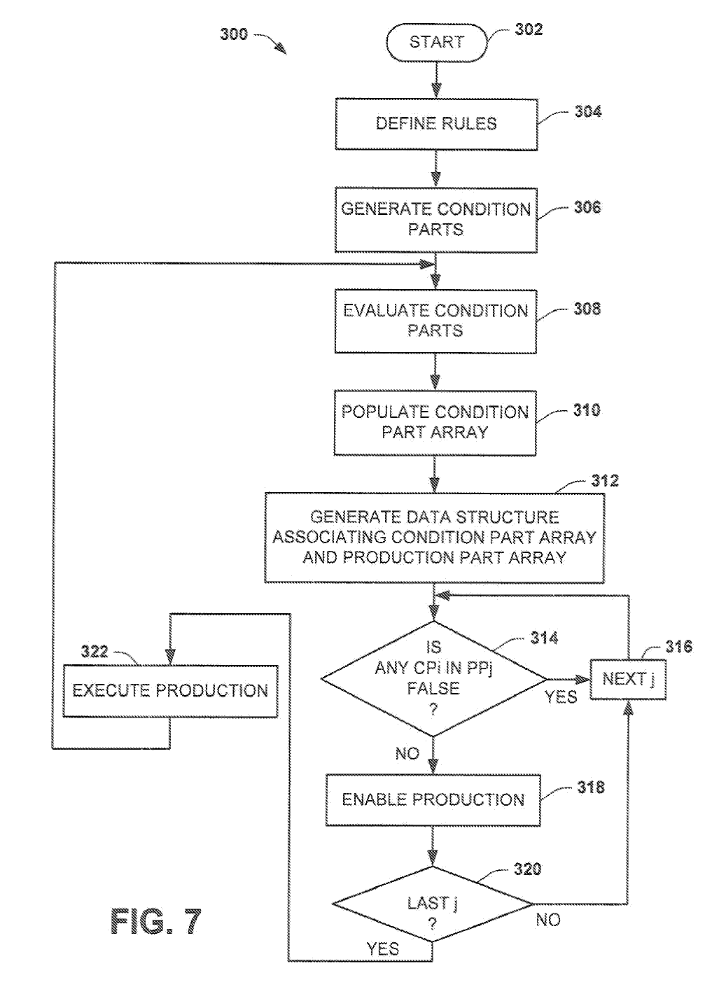

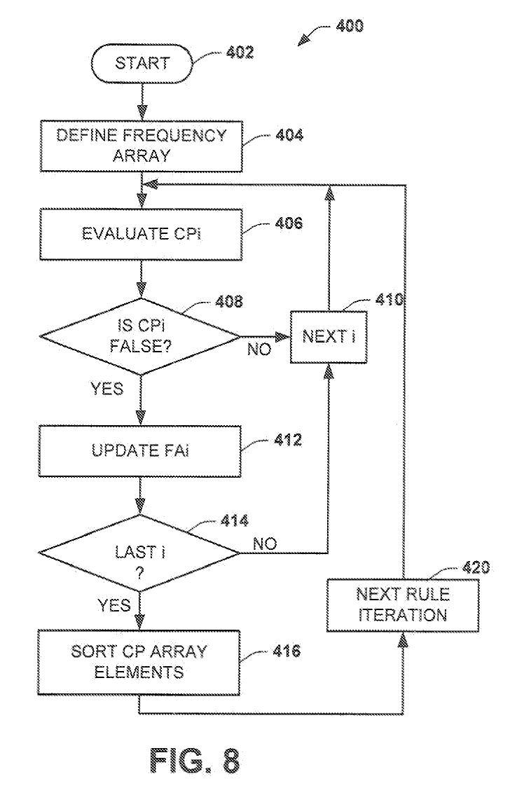

In view of the structural and functional features described above, certain methods will be better appreciated with reference to FIGS. 7 and 8. It is to be understood and appreciated that the illustrated actions, in other embodiments, may occur in different orders or concurrently with other actions. Moreover, not all features illustrated in FIGS. 7 and 8 may be required to implement a method according to the subject invention. It is to be further understood that the following methodology can be implemented in hardware (e.g., one or more processors, such as in one or more computer or special purpose computer device, such as an embedded system), software (e.g., stored in a computer readable medium or as executable instructions running on one or more processors), or as a combination of hardware and software.

FIG. 7 depicts an example of a method 300 that can be utilized for implementing a rules engine according to an aspect of the invention. The method 300 beings at 302, which may include instantiating one or more objects and setting variables and parameters to their starting values for use in the method 300. At 304 one or more rules are defined. As described herein, each rule includes one or more condition parts and a respective condition part that is to be executed if the condition parts are true. The defining of the rules at 304 can also include instantiating a condition part array, a production part array and a rule matrix, such as described herein. At 306, a plurality of condition parts are generated. The condition parts are generated according to rules established for given application. The condition parts include expressions programmed to ascertain whether corresponding expressions for each of the condition parts are satisfied based on a set of one or more input parameters. Those skilled in the art will understand and appreciate various types of expressions, such as Boolean expressions and other logical constructs, that may be utilized to form the condition parts generated at 306.

At 308, the condition parts are evaluated. For example, each of the condition parts can receive a value, such as true or false, indicating whether the expressions for each of the condition parts are valid or otherwise satisfied. At 310, a condition part array is populated based upon the evaluation of the condition parts. Thus the condition part array has a plurality of elements arranged according to an index. The array may be bounded or unbounded, as one or more condition parts may be added during operation of the rule system. At 312, a data structure is programmed for associating the condition part array and the production part array. For example, the data structure generated at 312 can be a two-dimensional array in which each of the elements of one dimension are associated with a condition part array and the elements of the other dimension are associated with the production part array. In this way, the value of each array element of the data structure can selectively identify on which one or more condition parts each of the production parts depends.

At 314, a determination is made as to whether any condition part element in a given production part is false if a condition part for a given production part is false the method proceeds to 316 in which the next production part is searched and the method returns to 314. In conjunction with going to the next production part, the production part having a false condition part is disabled such that the production will not be executed. For example, the production part element PPⱼ for a given rule can be set to false. If no condition part for the current production part is false (NO), indicating that the associated condition parts are all true, the method proceeds from 314 to 318. At 318, production is enabled for the current production pat PPⱼ. From 318 the method proceeds to 320 to determine if the last element of the production part array has been reached. If the last element of the production part array has not been reached the method proceeds from 320 to 316 to increment to the next production part. If the last production part element has been reached to 320, the method proceeds to 322. At 322, production for the enabled production parts are executed, such as by a production control engine. From 322 the method returns to 308 for a next iteration of the rules engine by repeating the evaluation of condition parts and enabling/disabling production parts in the current rule system.

As described herein, the rules engine can be self adaptive, which adaptation may vary based on a frequency at which the condition parts are false. FIG. 8 depicts a method 400 that can be employed for implementing such self-adaptive feature in a production rule system. The method 400 beings at 402, such as in conjunction with completing an iteration with a respective rules engine (e.g., following an affirmative determination at 320 of FIG. 7). At 404, the frequency array can be defined commensurate with the size of the condition part array for which the frequency is being evaluated for the self-adapting feature. At 406, the respective condition parts can be evaluated, such as corresponding of the elements in a condition part array. It is to be understood and appreciated that the evaluation can correspond to the evaluation associated with performing the rule processing shown and described with respect to FIG. 7 (e.g., at 308). Alternatively, a separate evaluation for the method 400 can be employed.

At 408, a determination is made as to whether a respective condition part element is false. If the condition part element is not false (NO), the method proceeds to 410 in which the method returns to 406 to evaluate the condition part for the next indexed element in the array. If the respective condition part is false (YES), the method proceeds from 408 to 412 in which the frequency array is updated for the corresponding index. Those skilled in the art will understand that the frequency information can be maintained in a variety of forms, such as a count value, as a relative likelihood of falsehood associated with each of the respective condition parts, or otherwise. At 412, the method proceeds to 414 in which a determination is made as to whether the last element in the condition part array has been reached. If the last element has not been reached (NO) the method proceeds to 410 to increment to the next condition part element. If the last element in the condition part array has been reached, the method proceeds to 416.

At 416, the condition part array elements are sorted based upon the likelihood of falsehood (updated at 412). For example, the first element of the beginning of the condition part array can correspond to the condition part having the greatest likelihood of being false. The likelihood of being false may correspond to a historical or time-averaged indication of each condition part being false. While a historical evaluation of being false may not necessarily indicate the likelihood of a given condition part being false in the future, in many systems and applications, such an evaluation will prove helpful and can thus be leveraged to improve performance of the rules engine.

What have been described above are examples and embodiments of the invention. It is, of course, not possible to describe every conceivable combination of components or methodologies for purposes of describing the invention, but one of ordinary skill in the art will recognize that many further combinations and permutations of the present invention are possible. Accordingly, the invention is intended to embrace all such alterations, modifications and variations that fall within the scope of the appended claims. In the claims, unless otherwise indicated, the article “a” is to refer to “one or more than one”.

What is claimed is:

1. A production rule system comprising:
an arrangement of condition part elements, each of the condition part elements comprising a condition value corresponding to an evaluation of one of a plurality of condition parts;
a production part array comprising an arrangement of production part elements, each of the production part elements comprising one of a plurality of production parts corresponding to an executable action; and
a data structure that selectively associates at least one of the condition part elements with each of the production part elements to define a plurality of rules, the production part associated with a given rule of the plurality of rules being executed depending on the condition value for the at least one of the condition part elements in the given rule.

2. The system of claim 1, wherein the arrangement of condition part elements comprises an array of the condition part elements, the system further comprising a condition part evaluator programmed to evaluate the plurality of condition parts in the condition part array, a corresponding value for each respective condition part being stored in the condition part array as the condition value.

3. The system of claim 2, wherein the production part associated with the given rule of the plurality of rules is executed based on the corresponding value for each of the plurality of condition parts associated with the given rule.

4. The system of claim 3, the production part element for the given rule being assigned a corresponding value for enabling execution of the respective production part as a function of the corresponding value determined for each of the plurality of condition parts associated with the given rule.

5. The system of claim 1, wherein the condition value for each respective condition part element is stored in the arrangement of condition elements as a binary value.

6. The system of claim 5, further comprising a rule evaluator programmed to determine whether to execute the production part associated with the given rule based on performing a logic AND operation on the binary value for each of the at least one condition part element associated with the given rule.

7. The system of claim 1, wherein each of the plurality of condition parts represents at least one conditional expression that is evaluated to provide the condition value for the respective condition part element.

8. The system of claim 1, wherein each of the plurality of condition parts comprises a plurality of Boolean expressions, the Boolean expressions of each of the plurality of condition parts being logically ANDed together to provide a binary value, representing an evaluation of each respective condition part, stored as the condition value for each respective condition part.

9. The system of claim 1, wherein the data structure is represented as a two-dimensional matrix having a plurality of matrix elements, at least some of the plurality of matrix elements having values that selectively associate a subset of at least one of the plurality of condition parts with each of the plurality of production part elements to define each of the plurality of rules.

10. The system of claim 1, further comprising a sorting function programmed to arrange each of the condition part elements in the arrangement of condition part elements with an order that varies according to a frequency at which each respective condition part has a predetermined value.

11. The system of claim 10, wherein the arrangement of condition part elements comprises an array of the condition part elements, further comprising a frequency engine programmed to determine a frequency value for each of the plurality condition parts indicative of the frequency at which each condition part has the predetermined value, the sorting function being programmed to arrange each of the condition part elements in the condition part array based on the respective frequency value associated with each of the plurality condition parts.

12. The system of claim 10, wherein the predetermined value is one of true of false.

13. A production rule system comprising:
means for storing a plurality of condition part elements, each of condition part elements representing an evaluation of a respective one of a plurality of condition parts;
means for storing a production part elements, each of the production part elements comprising one of a plurality of production parts corresponding to an executable action;
means for associating at least one of the condition part elements with each of the production part elements for providing each of a plurality of rules; and
means for executing the production part associated with a given rule of the plurality of rules depending on a value of the at least one of the condition part elements in the given rule.

14. The system of claim 13, further comprising means for evaluating the plurality of condition parts, a corresponding value for each of the plurality of condition parts being stored as a respective condition part element.

15. The system of claim 13, wherein the corresponding value for each respective condition part is a binary value stored in a respective one of the condition part elements, and
wherein the means for executing further comprises means for performing a logic AND operation on the binary value for each of the plurality of condition parts associated with each of the plurality of rules to determine whether execution of the production part associated with each of the plurality of rules is enabled.

16. The system of claim 13, wherein the means for associating further comprises a data structure represented as a two-dimensional matrix having a plurality of elements, the plurality of elements of the two-dimensional matrix having values that selectively associate a subset of at least one of the plurality of condition parts with each of the plurality of production parts to define each of the plurality of rules.

17. The system of claim 13, wherein the means for storing a plurality of condition parts stores each of the condition part elements in an array, the system further comprising means for dynamically arranging each of the condition part elements in the condition part array with an order that varies according to a frequency at which each respective condition part is one of true or false.

18. An embedded system comprising a processor and a memory, the embedded system having executable instructions in the memory for performing a method that comprises:
evaluating expressions for each of a plurality of condition parts;
populating condition part elements with values based on the evaluation of expressions;
associating at least one of the condition part elements with each of a plurality of production part elements to define each of a plurality of rules, each respective production part element corresponding to a respective one of a plurality of production parts; and
executing each of the plurality of production parts for a given rule of the plurality of rules depending on the value of the at least one condition part element that is associated with the respective production part element.

19. The method of claim 18, wherein the associating further comprises employing a matrix of rule elements, each of the rule elements having a value selected to associate each of the production part elements with the at least one condition part element on which execution of the corresponding production part depends.

20. The method of claim 17, further comprising dynamically arranging each of the condition part elements in a condition part array with an order that varies according to a frequency at which each respective condition part has a predefined value.
